(19) United States
(12) Patent Application Publication
(10) Pub. No.: US 2010/0070850 A1
(43) Pub. Date: Mar. 18, 2010

(54) COMMUNICATION APPARATUS, MAIL CONTROL METHOD, AND MAIL CONTROL PROGRAM

(75) Inventors: Yuji Yamaji, Kawasaki (JP); Kazuyuki Yamamura, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/622,981

(22) Filed: Nov. 20, 2009

Related U.S. Application Data
(63) Continuation of application No. PCT/JP2007/063046, filed on Jun. 28, 2007.

(51) Int. Cl. G06F 15/16; G06F 17/00

(52) U.S. Cl. 715/234; 709/206

(57) ABSTRACT

To send electronic mail in which text input in “body text” by a user who uses a mobile phone and a prestored template are combined with each other, the mobile phone stores therein a plurality of templates each containing a character insertion portion into which the text input by the user is to be inserted, receives from the user a selection of the template into which the text input in “body text” is to be inserted from among the stored templates, and inserts the text input by the user into the character insertion portion of the received template to thereby create HTML mail in which the template and the text are combined with each other.

### CROSS-REFERENCE TO RELATED APPLICATIONS

This application is a continuation of International Application No. PCT/JP2007/063046, filed on Jun. 28, 2007, the entire contents of which are incorporated herein by reference.

### FIELD

The embodiments discussed herein are directed to a communication apparatus, a mail control method, and a mail control program for sending electronic mail in which text input by a user who uses the communication apparatus and a prestored template are combined with each other.

### BACKGROUND

Conventionally, electronic mail (e-mail), in addition to voice call, has been widely used as a means of information communication by a computer terminal such as a mobile phone. In recent years, e-mail that is attached with images and HTML (Hyper Text Markup Language) mail that may send various types of information compared to the e-mail have been increasingly used.

Various technologies have been proposed for enabling the HTML mail to be easily used with the mobile phone. For example, Japanese Laid-open Patent Publication No. 2006-139340 discloses a conventional technology for editing HTML mail by using a template of the HTML mail or automatically combining text with the template of the HTML mail.

However, in the above-mentioned conventional technology, there has been a problem that it takes time to re-edit e-mail in which the text and the template are combined with each other.

More specifically, when input text and a template of HTML mail are combined with each other and then the input text is to be changed, the HTML mail need to be edited directly. Therefore, when a plurality of templates is provided, there is no way of selecting a template after text has already been input. In other words, when the created HTML mail is re-edited, the input text and the template that have been combined with each other need to be uncombined and an input of text and a selection of a template need to be performed again. Thus, operation becomes time-consuming and loads on a user increase.

### SUMMARY

According to an aspect of an embodiment of the present invention, a communication apparatus that sends electronic mail in which input text and a prestored template are associated with each other, the communication apparatus includes a template storage unit that stores therein a plurality of templates each containing a character insertion portion into which the input text is to be inserted; a template selecting unit that receives a selection of a template into which the text is to be inserted from among the templates stored in the template storage unit; and a mail creating unit that inserts the input text into the character insertion portion of the template received by the template selecting unit to create the electronic mail in which the template and the text are associated with each other.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram for explaining an outline and features of a mobile phone according to a first embodiment of the present invention;

FIG. 2 is a block diagram of a configuration of the mobile phone according to the first embodiment;

FIG. 3 is a diagram illustrating exemplary screen display for explaining a process of combining a template and text;

FIG. 4 is a flowchart of a procedure of an HTML-mail sending process performed by the mobile phone according to the first embodiment; and

FIG. 5 is a diagram illustrating an exemplary computer system that executes an HTML-mail sending program.

### DESCRIPTION OF EMBODIMENT(S)

Preferred embodiments of the present invention will be explained with reference to accompanying drawings. In the following descriptions, an outline and features of a communication apparatus (a mobile phone) according to one embodiment of the present invention are described first, followed by a configuration of the mobile phone and a process procedure performed by the mobile phone. Various modified examples of the embodiment will be described in the end.

### [a] First Embodiment

Outline and Features of Mobile Phone

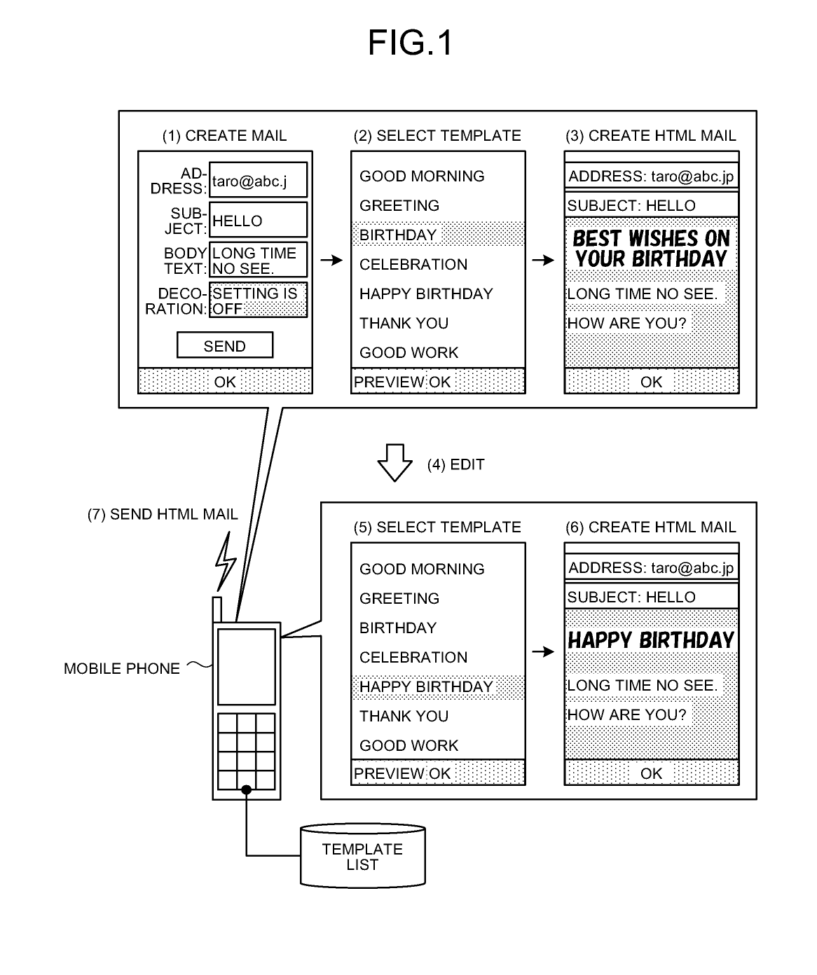

With reference to FIG. 1, an outline and features of the mobile phone according to the first embodiment will be described. FIG. 1 is a diagram for explaining an outline and features of the mobile phone according to the first embodiment. The mobile phone (corresponding to “a communication apparatus” mentioned in the appended claims) is a computer terminal capable of performing voice communication, mail communication, and the like. Examples of the mobile phone include a personal computer, a workstation, a home game console, an Internet television (TV), a portable digital assistant (PDA), and a mobile communication terminal including a personal handy-phone system (PHS). The mobile phone is also capable of loading an Internet browser that connects to the Internet and exchanging e-mail.

In this configuration, the outline of the mobile phone is that the mobile phone sends e-mail in which text input by a user who uses the mobile phone and a prestored template are combined with each other as mentioned earlier. Besides, a main feature of the mobile phone is to make it possible to easily re-edit the e-mail in which the text and the template are combined with each other.

To describe the main feature in more detail, the mobile phone stores therein a plurality of templates each containing a character insertion portion into which text input by a user is to be inserted. More specifically, the mobile phone stores therein templates, each containing the character insertion portion into which text, such as “Have a nice day today.” or “How about tomorrow at 18:00?”, that is input in “body text” of mail by a user is to be inserted, and each being provided so as to cover categories of various genres such as “greeting”, “celebration”, and “invitation”. Each of the templates stored in this example is image data that is pre-created in HTML format and that contains text, image, and the like.

The mobile phone receives from a user a selection of a template into which text is to be inserted from among a plurality of stored templates (see (1) and (2) of FIG. 1). For example, when receiving an instruction to create mail from a user, the mobile phone outputs a mail creation screen containing “address”, “subject”, “body text”, and “decoration (setting is OFF=no template is selected)” as illustrated in (1) of FIG. 1, and receives regular mail created by the user. Then, when the user selects “decoration” on the screen illustrated in (1) of FIG. 1, the mobile phone reads stored templates, outputs “template list” for display as illustrated in (2) of FIG. 1, and receives a selection of a template from the user. It is assumed here that the user has input “address=taro@abc.jp”, “subject=hello”, and “body text=Long time no see. How are you?” into the mobile phone. When a template is selected, contents of “decoration” is changed from “setting is OFF” to “setting is ON”.

The mobile phone then inserts the text that has been input by the user into the character insertion portion of the template that has been selected by the user to thereby create e-mail in which the template and the text are combined with each other (see (3) of FIG. 1). More specifically, in the example mentioned above, when “birthday” is selected from “template list” illustrated in (2) of FIG. 1, the mobile phone inserts “body text=Long time no see. How are you?” that has been input in (1) of FIG. 1 into a character input portion or character insertion portion of the template “birthday” to combine the text and the template with each other, so that HTML mail as illustrated in (3) of FIG. 1 is created.

Then, when the user inputs an instruction to edit the HTML mail that has been created by the combination (see (4) of FIG. 1), the mobile phone re-outputs “template list” for display (see (5) of FIG. 1). When the user selects “Happy Birthday” from “template list” that has been re-output for display, the mobile phone inserts “body text=Long time no see. How are you?” into the character input portion of the template “Happy Birthday” to combine the text and the template with each other, so that HTML mail as illustrated in (6) of FIG. 1 is created. When the user inputs an instruction to send the mail, the mobile phone sends the created HTML mail to an address (see (7) of FIG. 1). When contents of the body text is to be edited, the mobile phone receives amendments of the body text independent of the template and inserts the edited body text into the character insertion portion of the template.

In this manner, when editing HTML mail that has been combined with text once, the mobile phone according to the first embodiment need not edit the created HTML mail directly and may edit the HTML mail by changing only the template or only the text. Therefore, as the main feature described above, the e-mail in which the text and the template are combined with each other may easily be re-edited.

Configuration of Mobile Phone

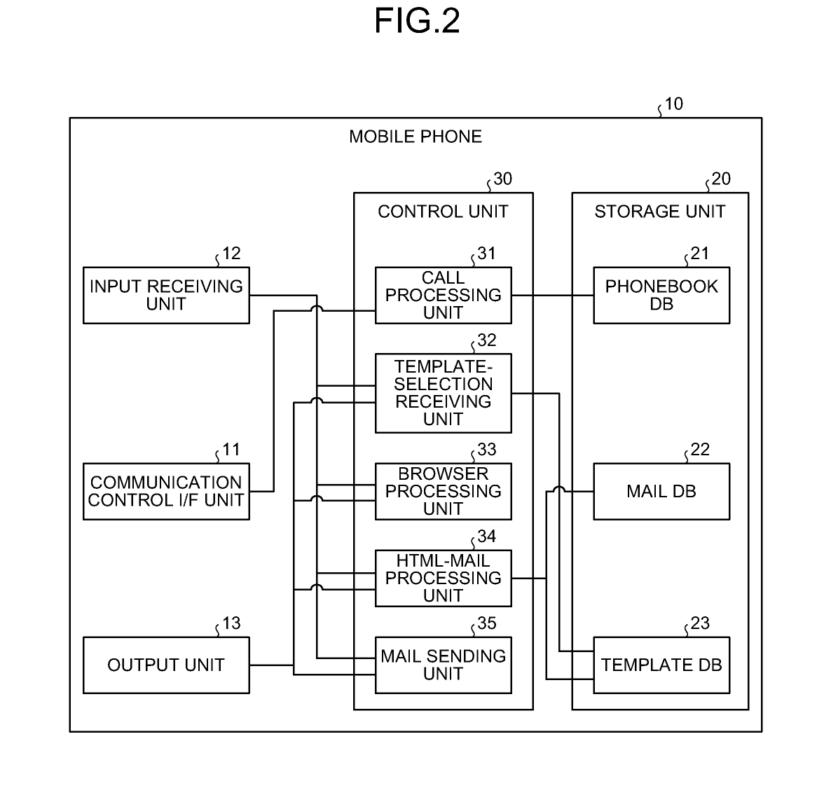

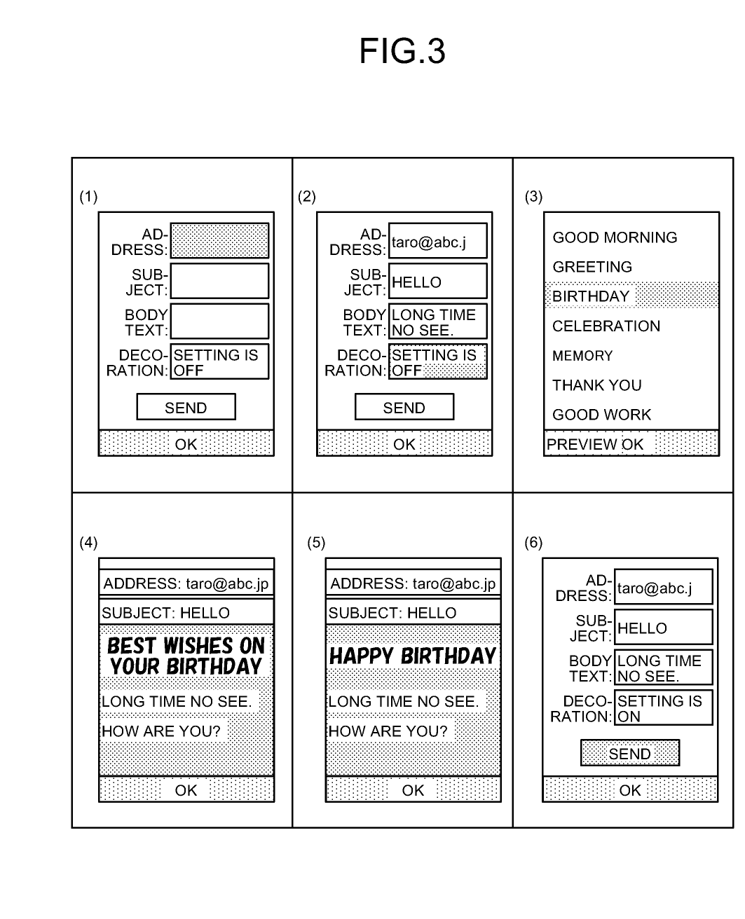

With reference to FIGS. 2 and 3, a configuration of the mobile phone illustrated in FIG. 1 will be described. FIG. 2 is a block diagram of the configuration of the mobile phone according to the first embodiment. FIG. 3 is a diagram illustrating exemplary screen display for explaining a process of combining a template and text. As illustrated in FIG. 2, a mobile phone 10 includes a communication control I/F (interface) unit 11, an input receiving unit 12, an output unit 13, a storage unit 20, and a control unit 30.

The communication control I/F unit 11 controls communication related to various information to be exchanged with other mobile phones or over the Internet. More specifically, the communication control I/F unit 11 controls various information related to voice communication that is performed with other mobile phones or IP phones, and controls various information related to Internet communication or mail communication to be established by the control unit 30 that will be described later.

The input receiving unit 12 includes a numeric keypad, a microphone, and the like, and receives an input of various information. For example, the input receiving unit 12 receives instructions to create mail, send mail, make a call, and the like from an owner of the mobile phone 10. When receiving various operational instructions from the owner, the input receiving unit 12 gives a notice of the received operational instructions to corresponding control units.

The output unit 13 includes a monitor (or a display, a touch panel, etc.), a speaker, and the like, and outputs various information. For example, the output unit 13 outputs a mail creation screen and a template selection screen for display for the owner.

The storage unit 20 stores therein data and computer programs necessary for various processes performed by the control unit 30. The storage unit includes, as components closely related to the present invention, a phonebook DB (database) 21, a mail DB 22, and a template DB 23.

The phonebook DB 21 stores therein a phone number indicating a call destination and a mail address for exchanging mail. For example, the phonebook DB 21 stores therein “Tokkyo Taro, 03-XXX-XXXX, tokkyo@a.com” as items “‘name’ of a person at a destination, ‘phone number’ of the person to whom call processing is performed, and ‘mail address’ representing a mail transmission destination and a mail reception source”. The information including various types of data and parameters described herein may be modified in any form, except when it is noted otherwise.

The mail DB 22 stores therein exchanged e-mail in association with exchanged date and exchanged destination and source. For example, the mail DB 22 stores therein e-mail by sorting the e-mail into categories of reception, transmission, deletion, and the like, i.e., categories of “received mail” for storing received mail, “transmitted mail” for storing transmitted mail, and “trash box” for storing discarded mail. The information including various types of data and parameters described herein may be modified in any form, except when it is noted otherwise.

The template DB 23 stores therein a plurality of templates each containing the character insertion portion into which text input by a user is to be inserted. For example, the template DB 23 stores therein templates, each containing the character insertion portion into which text, such as “Have a nice day today.” or “How about tomorrow at 18:00?”, that is input in “body text” of mail by a user is to be inserted, and each being provided so as to cover categories of various genres such as “greeting”, “celebration”, and “invitation”. Each of the templates stored in this example is image data that is pre-created in HTML format and that contains text, image, and the like.

The control unit 30 includes a built-in memory for storing control programs for OS (Operating System), computer programs containing various process procedures, and necessary data. The control unit 30 also includes, as components closely related to the present invention, a call processing unit 31, a template-selection receiving unit 32, a browser processing unit 33, an HTML-mail processing unit 34, and an mail sending unit 35, and performs various processes with these units.

The call processing unit 31 performs connection control for voice communication with other mobile phones (call processing). For example, the call processing unit 31 performs a process of calling a phone terminal, such as a mobile phone or an IP phone, that corresponds to a phone number stored in the phonebook DB 21, or a process of receiving a call from other phone terminal.

The template-selection receiving unit 32 receives, from a user via the input receiving unit 12, a selection of a template into which text is to be inserted from among the templates stored in the template DB 23. For example, when receiving an instruction to create mail from the user via the input receiving unit 12, the template-selection receiving unit 32 outputs a mail creation screen containing “address”, “subject”, “body text”, and “decoration” as illustrated (1) of FIG. 3, for display on the output unit 13. Then, when the user inputs information into “address”, “subject”, “body text”, and “decoration” and clicks “decoration” as illustrated in the screen of (2) of FIG. 3, the template-selection receiving unit 32 reads the templates stored in the template DB 23, outputs “template list” as illustrated in (3) of FIG. 3 for display, and receives a selection of a template from the user via the input receiving unit 12. Then, when the user inputs to the input receiving unit 12 an instruction to edit the HTML mail that has been created by the combination, the template-selection receiving unit 32 re-outputs “template list” for display. The template-selection receiving unit 32 corresponds to “a template selecting unit” mentioned in the appended claims.

The browser processing unit 33 performs various control on a browser that connects to the Internet. For example, when the input receiving unit 12 receives an input of an operational instruction to connect to the Internet from the owner, the browser processing unit 33 activates an Internet connection browser to connect to the Internet, and performs downloading of various information or the like.

The HTML-mail processing unit 34 inserts text that has been input by the user into the character insertion portion of a template that has been selected by the template-selection receiving unit 32 to thereby create HTML mail in which the template and the text are combined with each other. More specifically, in the above-mentioned example, when “birthday” is selected from “template list” illustrated in (3) of FIG. 3, the HTML-mail processing unit 34 inserts “body text=Long time no see. How are you?” that has been input in (2) of FIG. 3 into the character insertion portion of the template “birthday” to combine the text and the template with each other, so that HTML mail illustrated in (4) of FIG. 3 is created.

Then, when receiving an instruction to edit the HTML mail created by the combination from a user via the input receiving unit 12, the template-selection receiving unit 32 re-outputs “template list” for display on the output unit 13. When the user selects “Happy Birthday” from “template list” that has been re-output for display, the HTML-mail processing unit 34 inserts “body text=Long time no see. How are you?” into the character insertion portion of the template “Happy Birthday” to combine the text and the template with each other, so that HTML mail illustrated in (5) of FIG. 3 is created. The HTML-mail processing unit 34 corresponds to “a mail creating unit” mentioned in the appended claims.

The mail sending unit 35 sends regular mail or HTML mail to an address. More specifically, in the above-mentioned example, when the HTML-mail processing unit 34 creates HTML mail, the mail sending unit 35 outputs the created HTML mail as illustrated in (6) of FIG. 3 for display. Then, when the user clicks “send” on the screen of (6) of FIG. 3, the mail sending unit 35 sends the HTML mail that has been created and displayed to an address.

Process Performed by Mobile Phone

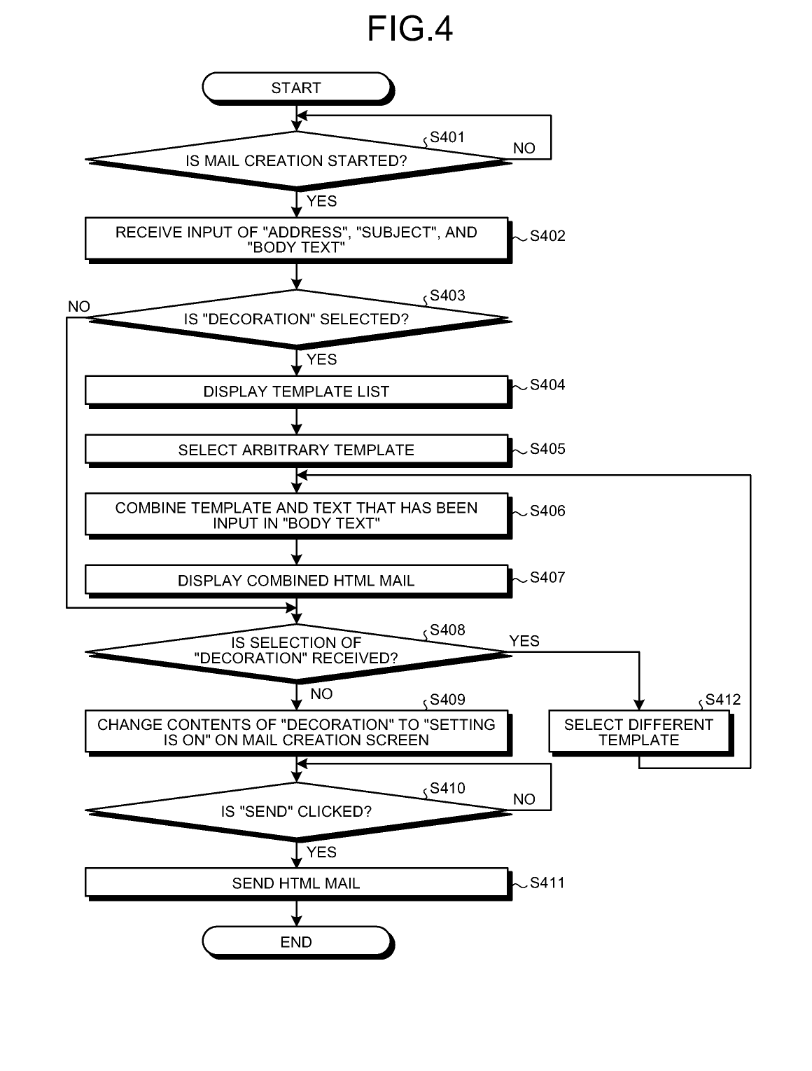

With reference to FIG. 4, a process performed by the mobile phone is described. FIG. 4 is a flowchart of a procedure of an HTML-mail sending process by the mobile phone according to the first embodiment.

As illustrated in FIG. 4, when the input receiving unit 12 receives an instruction to create mail and starts a mail creation process (YES at Step S401), the template-selection receiving unit 32 outputs a mail creation screen containing “address”, “subject”, “body text”, and “decoration”, for display on the output unit 13, and receives an input of “address”, “subject”, and “body text” from a user (Step S402).

When the user clicks “decoration” on the mail creation screen that is output for display on the output unit 13 (YES at Step S403), the template-selection receiving unit 32 outputs a list of the templates stored in the template DB 23 for display on the output unit 13 (Step S404).

Then, the template-selection receiving unit 32 receives via the input receiving unit 12 a selection of an arbitrary template from the list of the templates output for display on the output unit 13 (Step S405). The HTML-mail processing unit 34 combines the selected template and text that has been input in “body text” with each other (Step S406), and outputs the combined HTML mail for display on the output unit 13 (Step S407).

When the user additionally clicks “decoration” (YES at Step S408), the template-selection receiving unit 32 re-outputs the list of the templates stored in the template DB 23 for display on the output unit 13, and receives a selection of a template that is different from the previously-selected template via the input receiving unit 12 (Step S412). Then, the subsequent processes from Step S406 are repeated.

On the other hand, when the user does not additionally click “decoration” (NO at Step S408), the HTML-mail processing unit 34 fixes the template and changes “setting is OFF” contained in “decoration” to “setting is ON” (Step S409).

When the user clicks “send button” (YES at Step S410), the mail sending unit 35 sends the created HTML mail to an address (Step S411).

Effect According to the First Embodiment

In this manner, according to the first embodiment, e-mail in which a template and “body text” are combined with each other is created in the following manner: a plurality of templates is stored, each containing the character insertion portion into which “body text” as text input by a user is to be inserted; a selection of a template into which “body text” is to be inserted from among the templates stored in the template DB 23 is received from the user; and “body text” that has been input by the user is inserted into the character insertion portion of the selected template. Therefore, the e-mail in which “body text” and the template are combined with each other may easily be re-edited.

More specifically, when text “Thank you for your continuing support.” and the template “birthday celebration” are combined with each other, and then, the template is changed to a template “Happy Birthday”, e-mail can be created by inserting the text “Thank you for your continuing support” into the template “Happy Birthday”. Therefore, when HTML mail that has been combined with text once is to be edited, created e-mail need not be edited directly and combined e-mail can be edited by changing only a template or only text. Thus, the e-mail in which the text and the template are combined with each other can easily be re-edited, resulting in reducing loads on a user.

Furthermore, according to the first embodiment, HTML mail in which the template and “body text” are combined with each other is created in the following manner: a plurality of templates is stored, each containing the character insertion portion into which “body text” as text input by a user is to be inserted and each being created in HTML format; and “body text” that has been input by the user is inserted into the character insertion portion of the selected template. Therefore, the HTML mail in which “body text” and the template are combined with each other may easily be re-edited. Moreover, HTML mail is used instead of mail created by a special method, so that it is not necessary to take a type of a communication terminal at a destination into consideration. Therefore, loads on the user can be reduced.

### [b] Second Embodiment

While the embodiment of the present invention is described above, the present invention may be applied in various forms other than the above-described embodiment. The other embodiments are described below according to the following categories: (1) mail format, (2) destination, (3) text decoration, (4) display of templates, (5) system configuration etc., and (6) computer programs.

(1) Mail Format

While, in the first embodiment, an example is described in which mail in HTML format is created by the combination, the present invention is not limited to this example. For example, it is possible to create mail in various formats with markup language, such as XML (eXtensible Markup Language) or XHTML (eXtensible HyperText Markup Language), and the like.

(2) Destination

While, in the first embodiment, an example is described with reference to the drawings in which one destination is contained in “address”, the present invention is not limited to this example. It is possible to contain plural destinations in “address”, and it is possible to simultaneously CC or BCC HTML mail created for “address” as performed on regular mail.

(3) Text Decoration

While, in the first embodiment, an example is described in which a text string (text) input in “body text” is inserted into a selected template to combine them with each other, the present invention is not limited to this example. It is possible to decorate size, color and format of the text string (test) input in “body text” and insert the decorated text into the selected template to combine them with each other. More specifically, it is possible to decorate text according to user's preference by enlarging a font size, coloring the text, or changing fonts appropriately. Thus, user's usability may be enhanced and user retention may effectively be achieved.

(4) Display of Templates

While, in the first embodiment, an example is described in which all the templates stored in the template DB 23 are output for display and then a selection by a user is received, the present invention is not limited to this example. For example, it is possible to determine user's intention based on text input in “body text” by a user so that only templates corresponding to the determined user's intention or only templates that do not contain the text input in “body text” can be presented (output and displayed).

In this configuration, templates of various genres such as “celebration”, “greeting”, and “invitation” are stored, so that when a user inputs text “Happy Birthday”, it is presumed that a current genre corresponds to “celebration” based on “Happy Birthday” and then templates corresponding to “celebration” are presented. Thus, user's usability can be enhanced. Furthermore, when the user inputs text “Happy Birthday” and if the user uses a template containing text “Happy Birthday” in a form of text or image, the same text will be redundantly contained. To cope with this situation, templates other than a template containing text that may be the same as the input text are presented for the user, so that user's usability may be enhanced and user retention may effectively be achieved.

(5) System Configuration Etc.

Of the various processes explained in the present embodiments, it is acceptable to automatically perform a part or all of the process that is explained to be performed manually (e.g., the process of receiving input of “body text”). In addition, the process procedures, the control procedures, the specific names, and the information including various types of data and parameters that are presented in the text and the drawings may be modified in any form, except when it is noted otherwise.

The constituent elements of the apparatuses illustrated in the drawings are based on functional concepts. The constituent elements do not necessarily have to be physically arranged in the way illustrated in the drawings. In other words, the specific mode in which the constituent elements are distributed and integrated is not limited to the ones illustrated in the drawings. A part or all of the apparatuses can be distributed or integrated, either functionally or physically in any arbitrary units according to various loads and use condition (e.g., the template-selection receiving unit 32 and the HTML-mail processing unit 34 may be integrated with each other).

(6) Computer Program

The various processes explained in the exemplary embodiments may be realized by executing a predetermined program by a computer system such as a personal computer or a workstation. A computer system that executes a computer program having the same functions as those of the above embodiment will be described below as another embodiment of the present invention.

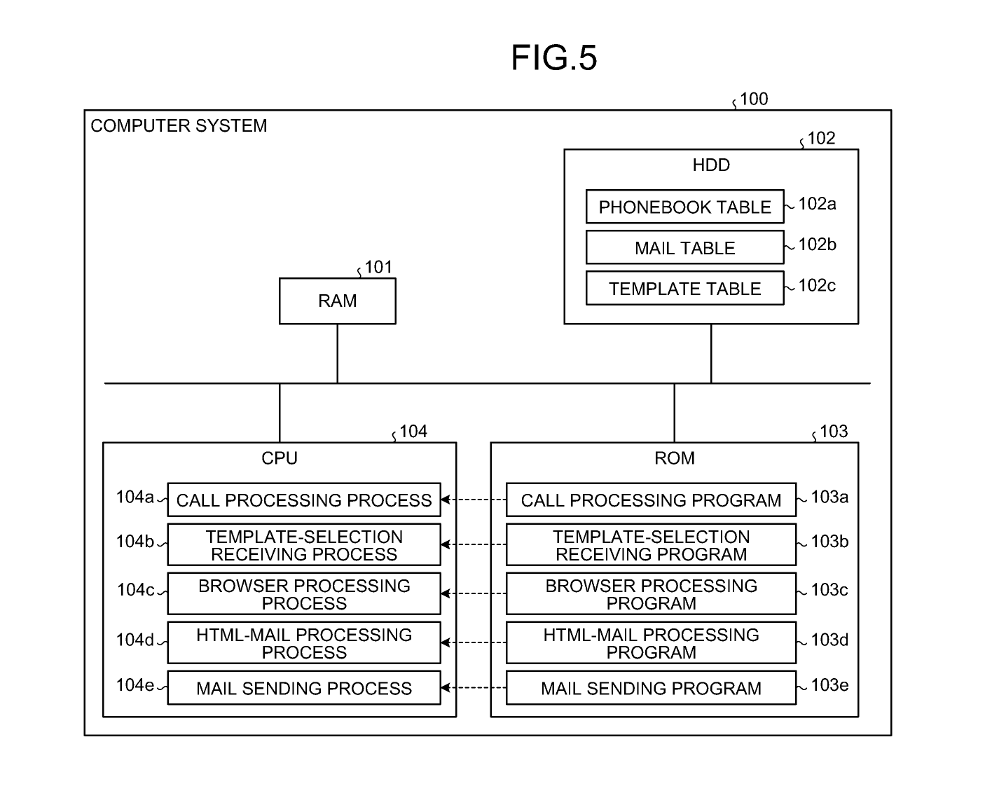

FIG. 5 is a diagram illustrating an exemplary computer system that executes an HTML-mail sending program. As illustrated in FIG. 5, a computer system 100 includes a random access memory (RAM) 101, a hard disk drive (HDD) 102, a read only memory (ROM) 103, and a central processing unit (CPU) 104. The ROM 103 prestores therein a computer program that realizes the same functions as those of the above embodiment, that is, as illustrated in FIG. 5, a call processing program 103a, a template-selection receiving program 103b, a browser processing program 103c, an HTML-mail processing program 103d, and a mail sending program 103e.

The CPU 104 reads and executes the programs 103a to 103e, so that a call processing process 104a, a template-selection receiving process 104b, a browser processing process 104c, an HTML-mail processing process 104d, and a mail sending process 104e are performed as illustrated in FIG. 5. The call processing process 104a corresponds to the call processing unit 31 illustrated in FIG. 2. Similarly, the template-selection receiving process 104b corresponds to the template-selection receiving unit 32, the browser processing process 104c corresponds to the browser processing unit 33, the HTML-mail processing process 104d corresponds to the HTML-mail processing unit 34, and the mail sending process 104e corresponds to the mail sending unit 35.

The HDD 102 contains a phonebook table 102a for storing a phone number as a call destination or a mail address for exchanging mail, a mail table 102b for storing exchanged e-mail in association with exchanged date and exchanged destination and source, and a template table 102c for storing a plurality of templates each containing the character insertion portion into which text input by a user is inserted. The phonebook table 102a corresponds to the phonebook DB 21, the mail table 102b corresponds to the mail DB 22, and the template table 102c corresponds to the template DB 23, as illustrated in FIG. 2.

The above-mentioned programs 103a to 103e need not be stored in the ROM 103, and may be stored in “a removable recording medium” such as a flexible disk (FD), a compact disk read only memory (CD-ROM), a magneto-optical (MO) disk, a digital versatile disk (DVD), a magneto-optical disk, and an integrated circuit (IC) card to be inserted into the computer system 100. Alternately, the programs 103a to 103e can be stored in “a fixed physical medium” such as an internal hard disk drive (HDD) provided in the computer system 100 or an external HDD attached to the computer system 100. Further, the programs 103a to 103e may be stored in “other computer system” connected to the computer system 100 via a public line, the Internet, a local area network (LAN), or a wide area network (WAN) so that the computer system 100 can reads out the programs therefrom for the execution.

According to the embodiments, e-mail in which a template and “body text” are combined with each other is created in the following manner: a plurality of templates is stored, each containing the character insertion portion into which “body text” as text input by a user is to be inserted; a selection of a template into which “body text” is to be inserted from among the templates stored in a template DB is received from the user; and “body text” that has been input by the user is inserted into the character insertion portion of the selected template. Therefore, the e-mail in which “body text” and the template are combined with each other may easily be re-edited.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication apparatus that sends electronic mail in which input text and a prestored template are associated with each other, the communication apparatus comprising:
a template storage unit that stores therein a plurality of templates each containing a character insertion portion into which the input text is to be inserted;
a template selecting unit that receives a selection of a template into which the text is to be inserted from among the templates stored in the template storage unit; and
a mail creating unit that inserts the input text into the character insertion portion of the template received by the template selecting unit to create the electronic mail in which the template and the text are associated with each other.

2. The communication apparatus according to claim 1, wherein
the template storage unit stores therein a plurality of templates each containing the character insertion portion into which the input text is to be inserted and each being created in HTML format, and
the mail creating unit inserts the input text into the character insertion portion of the template received by the template selecting unit to create HTML mail in which the template and the text are associated with each other.

3. The communication apparatus according to claim 2, further comprising:
a text decorating unit that decorates size, color, or format of the input text, wherein
the mail creating unit inserts the text decorated by the text decorating unit into the character insertion portion of the template received by the template selecting unit to create the HTML mail in which the template and the text are associated with each other.

4. The communication apparatus according to claim 1, further comprising:
an intention determining unit that determines user's intention based on the input text, with respect to the templates stored in the template storage unit, wherein
the template selecting unit presents templates corresponding to the user's intention determined by the intention determining unit, and receives a selection of the template into which the text is inserted from among the presented templates.

5. The communication apparatus according to claim 1, further comprising:
a text redundancy selecting unit that selects templates that do not contain the input text from among the templates stored in the template storage unit, wherein
the template selecting unit presents the templates selected by the text redundancy selecting unit from among the templates stored in the template storage unit, and receives a selection of the template into which the text is inserted from among the presented templates.

6. A mail control method suitable for sending electronic mail in which input text and a prestored template are associated with each other, the mail control method comprising:
storing in a template storage unit a plurality of templates each containing a character insertion portion into which the input text is to be inserted;
receiving a selection of the template into which the text is to be inserted from among the templates stored in the template storage unit; and
inserting the input text into the character insertion portion of the template received by the receiving to create the electronic mail in which the template and the text are associated with each other.

7. A computer-readable storage medium that stores a mail control program for sending electronic mail in which input text and a prestored template are associated with each other, the mail control program causing a computer to execute a process comprising:
storing in a template storage unit a plurality of templates each containing a character insertion portion into which the input text is to be inserted;
receiving a selection of the template into which the text is to be inserted from among the templates stored in the template storage unit; and
inserting the input text into the character insertion portion of the template received by the receiving to create the electronic mail in which the template and the text are associated with each other.
